(19) United States
(12) Patent Application Publication
(10) Pub. No.: US 2019/0149068 A1
(43) Pub. Date: May 16, 2019

(54) MOTOR CONTROLLER, POWER CONVERTER, AUXILIARY POWER SOURCE, AND METHOD FOR CONTROLLING AUXILIARY POWER SOURCE

(71) Applicant: KABUSHIKI KAISHA YASKAWA DENKI, Kitakyushu-shi (JP)

(72) Inventors: Mitsujiro SAWAMURA, Kitakyushu-shi (JP); Shouta KAWAHARA, Kitakyushu-shi (JP); Tatsuaki WADA, Kitakyushu-shi (JP)

(73) Assignee: KABUSHIKI KAISHA YASKAWA DENKI, Kitakyushu-shi (JP)

(21) Appl. No.: 15/993,757

(22) Filed: May 31, 2018

(30) Foreign Application Priority Data
Nov. 10, 2017 (JP) 2017-217303

(51) Int. Cl. H02P 3/18; H02J 3/30; H02J 3/32; H02J 1/16

(52) U.S. Cl. CPC H02P 3/18; H02J 1/16; H02J 3/32; H02J 3/30

(57) ABSTRACT

A motor controller includes an AC-to-DC converter that converts AC power from an AC power source into DC power and supplies the DC power to a DC bus line, an auxiliary power source that charges the DC bus line with the DC power and discharges the DC power from the DC bus line, and a first inverter that controls power supply to a motor using the DC power from the DC bus line. The auxiliary power source includes a rotating electrical machine, a flywheel connected to the machine, a second inverter that supplies power to the machine using the DC power on the DC bus line and regenerates the power from the machine into the DC power on the DC bus line, and control circuitry that controls the second inverter to cause rotational angle velocity of the flywheel to keep positive correlation with bus-to-bus voltage of the DC bus line.

### CROSS-REFERENCE TO RELATED APPLICATIONS

The present application claims priority under 35 U.S.C. §119 to Japanese Patent Application No. 2017-217303, filed Nov. 10, 2017. The contents of this application are incorporated herein by reference in their entirety.

### BACKGROUND

### Field of the Invention

The present invention relates to a motor controller, a power converter, an auxiliary power source, and a method for controlling an auxiliary power source.

### Discussion of the Background

JP 5291763B discloses a motor driver that uses both a capacitor accumulator and a flywheel accumulator. In controlling charging and discharging of the flywheel accumulator, the motor driver controls the angular velocity of a flywheel of the flywheel accumulator.

### SUMMARY

According to one aspect of the present invention, a motor controller includes an AC-to-DC converter that converts AC power from an AC power source into DC power and supplies the DC power to a DC bus line, an auxiliary power source that charges the DC bus line with the DC power and discharges the DC power from the DC bus line, and a first inverter that controls power supply to a motor using the DC power from the DC bus line. The auxiliary power source includes a rotating electrical machine, a flywheel connected to the rotating electrical machine, a second inverter that supplies power to the rotating electrical machine using the DC power on the DC bus line and regenerates the power from the rotating electrical machine into the DC power on the DC bus line, and control circuitry that controls the second inverter to cause a rotational angle velocity of the flywheel to keep a positive correlation with a bus-to-bus voltage of the DC bus line.

According to another aspect of the present invention, a power converter includes an AC-to-DC converter that converts AC power from an AC power source into DC power and supplies the DC power to a DC bus line, and an auxiliary power source that charges the DC bus line with the DC power and discharges the DC power from the DC bus line. The auxiliary power source includes a rotating electrical machine, a flywheel connected to the rotating electrical machine, a second inverter that supplies power to the rotating electrical machine using the DC power on the DC bus line and that regenerates the power from the rotating electrical machine into the DC power on the DC bus line, and control circuitry that controls the second inverter to cause a rotational angle velocity of the flywheel to keep a positive correlation with a bus-to-bus voltage of the DC bus line.

According to yet another aspect of the present invention, an auxiliary power source for charging a DC bus line with DC power and discharging the DC power from the DC bus line includes a rotating electrical machine, a flywheel connected to the rotating electrical machine, an inverter that supplies power to the rotating electrical machine using the DC power on the DC bus line and regenerates the power from the rotating electrical machine into the DC power on the DC bus line, and control circuitry that controls the inverter to cause a rotational angle velocity of the flywheel to keep a positive correlation with a bus-to-bus voltage of the DC bus line.

According to still another aspect of the present invention, a method for controlling an auxiliary power source includes controlling an inverter of the auxiliary power source to cause a rotational angle velocity of a flywheel of the auxiliary power source to keep a positive correlation with a bus-to-bus voltage of a DC bus line. The auxiliary power source includes a rotating electrical machine, the flywheel connected to the rotating electrical machine, and the inverter that supplies power to the rotating electrical machine using DC power on the DC bus line and regenerates the power from the rotating electrical machine into the DC power on the DC bus line.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a schematic illustrating a circuit configuration of a motor controller according to an embodiment;

FIG. 2 is a diagram illustrating a specific configuration of a power source inverter;

FIG. 3 is a diagram illustrating a comparative configuration in which a charging-discharging capacitor is directly connected to a DC bus line and disposed between the DC bus line;

FIG. 4 illustrates exemplary control blocks for velocity control performed by a controller;

FIG. 5 shows results of simulations of a charging-discharging test where no auxiliary power source is provided;

FIG. 6 shows results of simulations of a charging-discharging test where a charging-discharging capacitor is provided as an auxiliary power source;

FIG. 7 shows results of simulations of a charging-discharging test where an auxiliary power source according to the embodiment is provided as an auxiliary power source; and

FIG. 8 illustrates exemplary control blocks for velocity control performed by the controller where the velocity control is velocity sensor-less control.

### DESCRIPTION OF THE EMBODIMENTS

The embodiments will now be described with reference to the accompanying drawings, wherein like reference numerals designate corresponding or identical elements throughout the various drawings.

### Schematic Configuration of Motor Controller

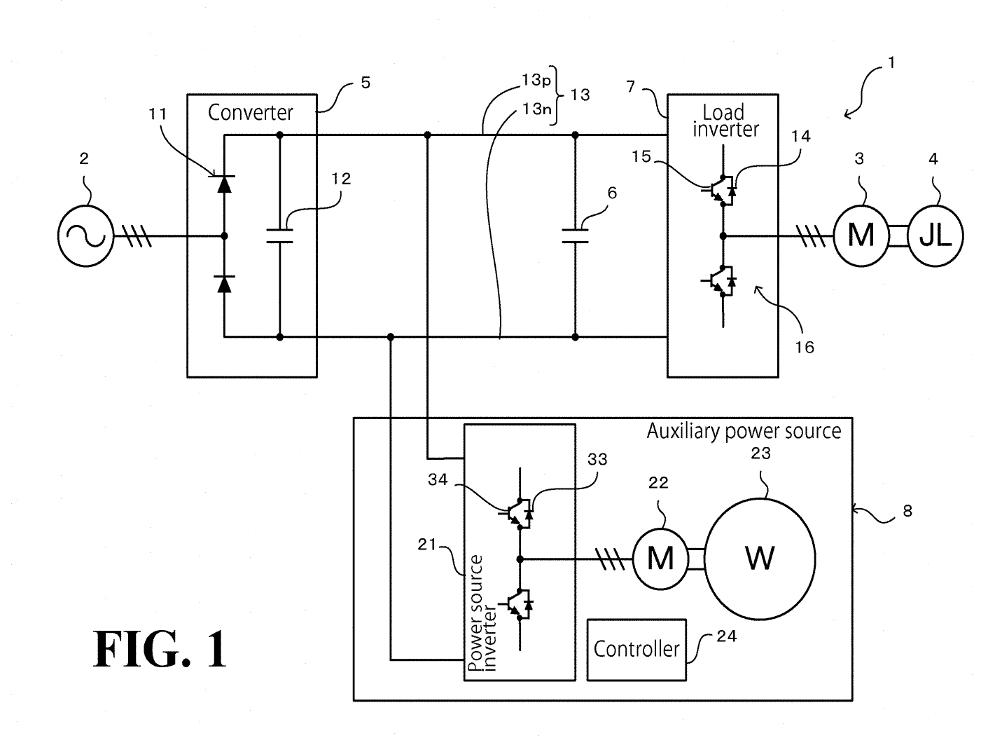

FIG. 1 is a schematic illustrating a circuit configuration of a motor controller 1 according to this embodiment. The motor controller 1 converts alternating-current (AC) power supplied from an external AC power source 2 into direct-current (DC) power, and converts the DC power into predetermined AC power. Then, the motor controller 1 supplies the predetermined AC power to a load motor 3. In this manner, the motor controller 1 controls driving of the load motor 3 and a load machine 4, which is connected to the load motor 3. Referring to FIG. 1, the motor controller 1 includes a converter 5, a surge-dedicated smoothing capacitor 6, a load inverter 7, and an auxiliary power source 8.

The converter 5 (AC-to-DC converter) includes rectifiers 11 and a power source-dedicated smoothing capacitor 12. The rectifiers 11 are diode bridges, for example, that rectify AC power from the external AC power source into DC power. The power source-dedicated smoothing capacitor 12 smoothens the DC power and supplies the smoothened DC power to a DC bus line 13.

The surge-dedicated smoothing capacitor 6 extends between and is connected to wirings of the DC bus lines, and has a comparatively small capacity for surge protection purposes.

The load inverter 7 (first inverter) includes a switching circuit 16. The switching circuit 16 includes bridge-connected semiconductor switching elements 15, each of which is connected in parallel to a flywheel diode 14. The load inverter 7 causes a drive controller, not illustrated, to perform pulse width modulation (PWM) control to switch each of the semiconductor switching elements 15 in a desired manner. In this manner, the load inverter 7 converts the DC power on the DC bus line 13 into an AC voltage having a desired frequency and a desired waveform, and supplies the AC voltage to the load motor 3 so as to control driving of the load motor 3. The load inverter 7 also has a function of regenerating regeneration power from the load motor 3 to the DC bus line 13. In the following description, the circuit made up of the converter 5, the surge-dedicated smoothing capacitor 6, and the load inverter 7 will be referred to as main circuit. The load motor 3 is a non-limiting example of the motor recited in the appended claims.

The auxiliary power source 8 includes a power source inverter 21, a power source motor 22, and a flywheel 23 (these elements will be detailed later). The auxiliary power source 8 is connected to and disposed between the wirings of the DC bus line 13 of the main circuit. With this configuration, the auxiliary power source 8 performs interchange of energy between the electric energy on the DC bus line 13 and the rotational motion energy on the flywheel 23. That is, by actively controlling rotational motion of the flywheel 23, the auxiliary power source 8 selectively performs a charging operation and a discharging operation with respect to the DC bus line 13.

In the motor controller 1 with the configuration described hereinbefore, the control-target load motor 3 may occasionally have a high throughput. In this case, if the driving of the load motor 3 is controlled to make sharp acceleration and/or sharp deceleration, the DC voltage across the DC bus line 13 (bus-to-bus voltage) may vary greatly, resulting in a great excess or a great shortage of the DC power. This may make the motor controller instable. In light of the circumstances, the auxiliary power source 8 selectively performs power peak shaving or power assistance, depending on how the DC voltage in the main circuit is changing. Specifically, when the bus-to-bus voltage has increased, the auxiliary power source 8 converts the DC power corresponding to the increased portion of the bus-to-bus voltage into rotational motion energy for the flywheel 23, and causes the rotational motion energy to accumulate in the flywheel 23. In this manner, the auxiliary power source 8 performs power peak shaving of charging the auxiliary power source 8 with the DC power on the DC bus line 13. When the bus-to-bus voltage has decreased, the auxiliary power source 8 compensates for the decreased portion of the bus-to-bus voltage by converting the rotational motion energy on the flywheel 23 into DC power. In this manner, the auxiliary power source 8 performs power assistance of discharging (regenerating) DC power. That is, the auxiliary power source 8 serves as a “flywheel battery” in that the auxiliary power source 8 performs a charging operation or a discharging operation, depending on an excess or shortage of the DC power on the DC bus line 13 of the main circuit, by performing interchange of energy between the electric energy on the DC bus line 13 and the rotational motion energy on the flywheel 23.

### Detailed Configuration and Functions of Auxiliary Power Source

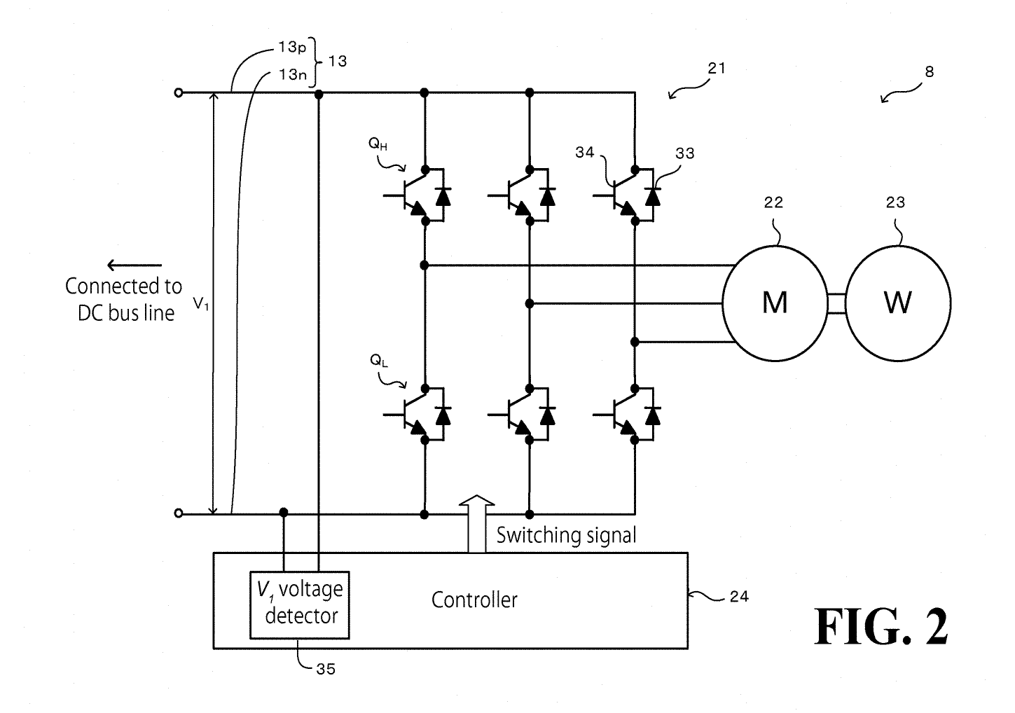

FIG. 2 is a diagram illustrating a specific configuration of the auxiliary power source 8. The auxiliary power source 8 includes a controller 24, in addition to the power source inverter 21, the power source motor 22, and the flywheel 23, described above.

The power source inverter 21 (second inverter) is a circuit made up of three parallel bridge-connected series circuits each made up of two arm-switching elements Q_{H} and Q_{L} connected in series to each other. Each of the arm-switching elements Q_{H} and Q_{L} is made up of a flywheel diode 33 and a semiconductor switching element 34 connected in parallel to each other. At both ends of the three parallel connections, the power source inverter 21 is connected to the wirings of the DC bus line 13, with an intermediate point between the two arm-switching elements Q_{H} and Q_{L} of each of the three parallel connections being connected to a different one of the three phase terminals of the power source motor 22, which is a three-phase AC motor. With this configuration, the power source inverter 21 has its semiconductor switching elements 34 switched in a desired manner by switching signals output from the controller 24, described later. In this manner, the power source inverter 21 serves a function of converting the DC power on the DC bus line 13 into three-phase AC power and supplying the three-phase AC power to the power source motor 22. The power source inverter 21 also has a function of converting (regenerating) three-phase AC power regenerated from the power source motor 22 into DC power on the DC bus line 13.

The power source motor 22 (rotating electrical machine) is a rotatable three-phase AC motor having an output shaft mechanically connected to the flywheel 23, which has a high fixed inertia (inertia moment).

The controller 24 includes a bus-to-bus voltage detector 35 (which is simply termed “V₁ voltage detector” in FIG. 2). The bus-to-bus voltage detector 35 detects bus-to-bus voltage V₁ between a positive wiring 13p and a negative wiring 13n of the DC bus line 13. Then, the controller 24 performs PWM control based on a detection value obtained by the bus-to-bus voltage detector 35 so as to output a switching signal that controls switching of the arm-switching elements Q_{H} and Q_{L}.

In the auxiliary power source 8 with the configuration described hereinbefore, the power source inverter 21 supplies driving power to the power source motor 22. This causes the power source motor 22 to function as an electrical machine to drive the flywheel 23 into rotation. That is, electric energy is converted into rotational motion energy, which accumulates in the flywheel 23. When the electric energy supplied to the power source motor 22 is lower than the rotational motion energy on the flywheel 23, slowing-down rotation of the flywheel 23 causes the power source motor 22 to function as an electric generator to output regeneration power to the power source inverter 21. That is, rotational motion energy is converted into electric energy, which is discharged to the power source inverter 21.

The above charging operation and discharging operation are switched based on the balance between: the duty ratio of the PWM control that the controller 24 performs to switch the arm-switching elements Q_{H} and Q_{L}; and the bus-to-bus voltage V₁ of the DC bus line 13. That is, in order to intentionally switch between the charging operation and the discharging operation in the auxiliary power source 8, it is necessary to monitor both the rotational angle velocity of the flywheel 23 and the bus-to-bus voltage V₁ and to perform power supply control with respect to the power source motor 22 appropriately, that is, with the rotational angle velocity and the bus-to-bus voltage V₁ taken into consideration in the power supply control.

### Method of Power Supply Control of Power Source Motor

In this embodiment, the auxiliary power source 8 is originally intended, as described above, to perform peak shaving control of charging the auxiliary power source 8 (thereby accelerating the flywheel 23) when the bus-to-bus voltage V₁ increases, and to perform peak assistance control of discharging from the auxiliary power source 8 (thereby decelerating the flywheel 23) when the bus-to-bus voltage V₁ decreases. It is difficult, however, to adjust the timing at which to switch between the peak shaving control and the peak assistance control and difficult to adjust the step of varying the amount of charging in the peak shaving control and the amount of discharging in the peak assistance control. This necessitates a complicated sequence, often resulting in complicated power supply control with respect to the power source motor 22.

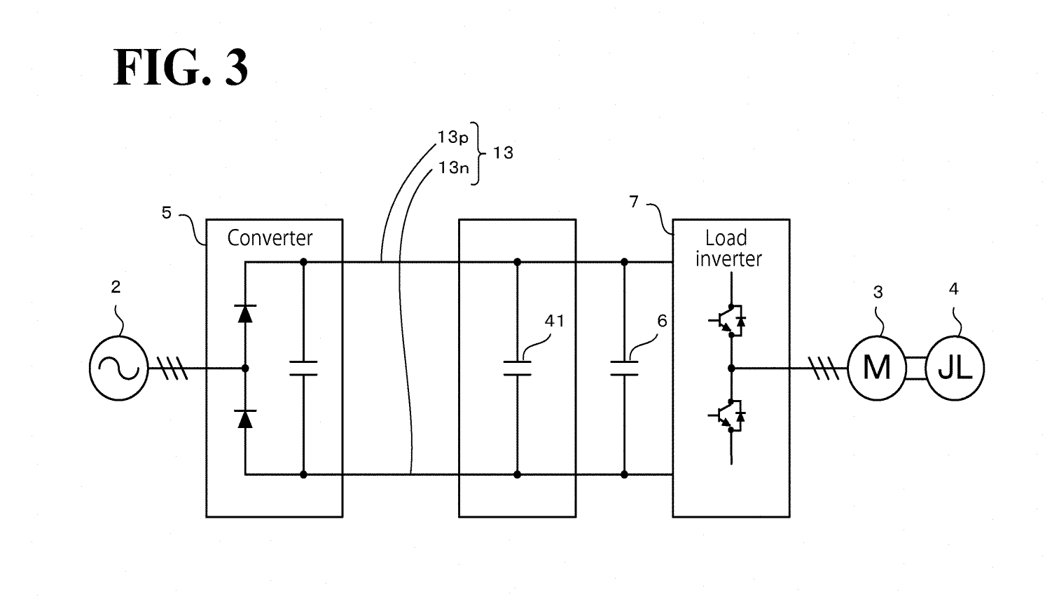

In this respect, in the comparative example illustrated in FIG. 3, a charging-discharging capacitor 41 is directly connected to and disposed between the wirings of the DC bus line 13. This configuration eliminates the need for the above-described control of switching between a charging operation and a discharging operation. Thus, this configuration is most preferable from a control easiness standpoint. In view of the circumstances, in the power supply control with respect to the power source motor 22, this embodiment performs software-implemented control with respect to the rotational angle velocity of the flywheel 23 using the controller 24. This software-implemented control enables the auxiliary power source 8 as a whole to perform charging and discharging operations through behaviors equivalent to behaviors of a single charging-discharging capacitor 41 of the comparative example illustrated in FIG. 3.

Specifically, when the auxiliary power source 8 as a whole according to this embodiment is assumed to be equivalent to the single charging-discharging capacitor 41, it can also be assumed that approximately equal energy is accumulable in the auxiliary power source 8 and the single charging-discharging capacitor 41, which can be represented by the following Formula (1):

$$\frac{1}{2} {CV}^{2} = \frac{1}{2} J {ω}^{2} \qquad ( 1 )$$

In Formula (1), C is capacitance of the charging-discharging capacitor 41 (capacitor); V is interterminal voltage of the charging-discharging capacitor 41; J is inertia of a rotatable portion as a whole, the rotatable portion of the auxiliary power source 8 including the rotor of the power source motor 22 and the flywheel 23 (the rotatable portion also includes couplings and similar devices); and ω is rotational angle velocity of the rotatable portion.

From Formula (1), the rotational angle velocity ω and the capacitance C can be isolated as in the following Formulae (2) and (3), respectively:

$$\begin{matrix}ω = \sqrt{\frac{C}{J}} V & ( 2 ) \\ C = {J ( \frac{ω}{V} )}^{2} & ( 3 )\end{matrix}$$

Formula (2) shows that the above-described equivalency can be maintained as long as the rotational angle velocity ω of the flywheel 23 has a positive correlation with the bus-to-bus voltage V₁; more specifically, as long as the rotational angle velocity ω is proportionally related to the bus-to-bus voltage V₁(ω=(C/J)^{1/2}·V₁). With the equivalency maintained, Formula (3) shows that the charging capacity of the auxiliary power source 8 can be assumed to be equivalent to the capacitance C (=J·(ω/V₁)²).

Thus, in this embodiment, the power source inverter 21 of the auxiliary power source 8 performs power supply control with respect to the power source motor 22 in such a manner that the rotational angle velocity ω of the flywheel 23 is, at any time, in a direct-proportional correlation with the bus-to-bus voltage V₁ with a proportional coefficient of (C/J)^{1/2}. With the simple control of keeping a direct-proportional correlation between the rotational angle velocity w of the flywheel 23 and the bus-to-bus voltage V₁, the charging-discharging control of the auxiliary power source 8 is implemented without the necessity to focus on the switching between charging control (peak shaving control) and discharging control (peak assistance control) and with responsivity high enough to automatically accommodate to an increase or decrease in the bus-to-bus voltage V₁. Also, adjusting the inertia J in a desired manner facilitates the setting of the charging capacity C of the auxiliary power source 8 according to an expected range of variation of the bus-to-bus voltage V₁ of the DC bus line 13 of the main circuit.

### Exemplary Feedback Control Block

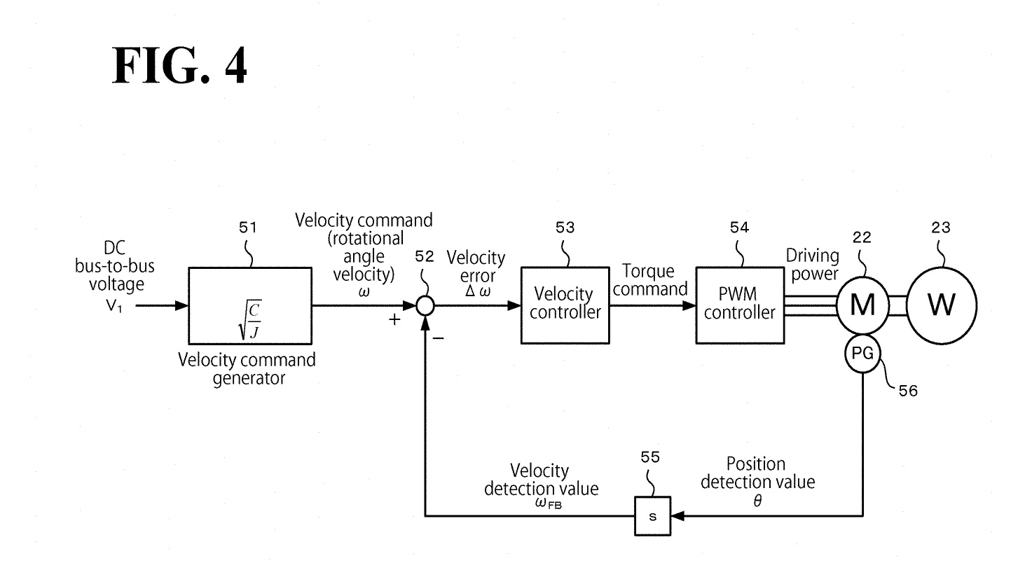

FIG. 4 illustrates exemplary feedback control blocks for implementing power supply control with respect to the power source motor 22 according to this embodiment. The control blocks are illustrated in transfer function form and included in the controller 24 of the auxiliary power source 8 in a software-implemented manner. Referring to FIG. 4, the controller 24 includes a velocity command generator 51, a subtractor 52, a velocity controller 53, a PWM controller 54, and a velocity converter 55.

The velocity command generator 51 multiplies the bus-to-bus voltage V₁ detected by the bus-to-bus voltage detector 35 by a predetermined proportional coefficient ((C/J)^{1/2}), and regards the obtained product as velocity command ω.

The subtractor 52 subtracts velocity detection value ω_{FB}, described later, from the velocity command ω, and outputs the obtained difference as velocity error Δω.

The velocity controller 53 generates a torque command by performing, for example, proportional-integral (PI) control with respect to the input velocity error Δω.

The PWM controller 54 performs switching of the power source inverter 21 (not illustrated in FIG. 4) by PWM control with a duty ratio based on the above-described torque command. In this manner, the PWM controller 54 converts the DC power on the DC bus line 13 into AC power and supplies the AC power to the power source motor 22.

The power source motor 22 includes a position detector 56, such as an encoder (not illustrated in FIGS. 1 and 2). The position detector 56 detects the rotation angle of the power source motor 22 (the flywheel 23) as position detection value θ. The velocity converter 55 converts the position detection value θ into velocity detection value ω_{FB} of the power source motor 22, and outputs the velocity detection value ω_{FB} to the subtractor 52. The velocity converter 55 may be implemented by a “differentiator (s)”.

With these feedback control blocks, the controller 24 generates a velocity command ω that is in a direct-proportional correlation with the bus-to-bus voltage V₁ detected at the present point of time with the proportional coefficient being (C/J)^{1/2}. Then, the controller 24 controls driving of the flywheel 23 to cause the rotational angle velocity of the flywheel 23 to follow the velocity command ω. That is, the controller 24 performs power supply control with respect to the power source motor 22 in such a manner that the rotational angle velocity ω of the flywheel 23 is at any time in a direct-proportional correlation with the bus-to-bus voltage V₁ with the proportional coefficient being (C/J)^{1/2}.

### Results of Simulations

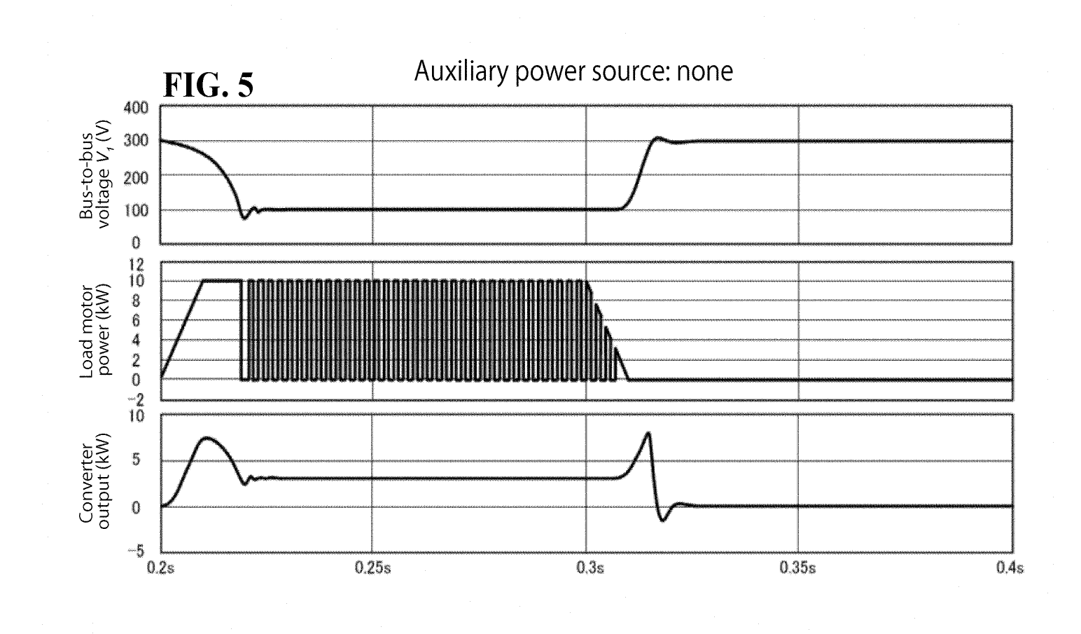

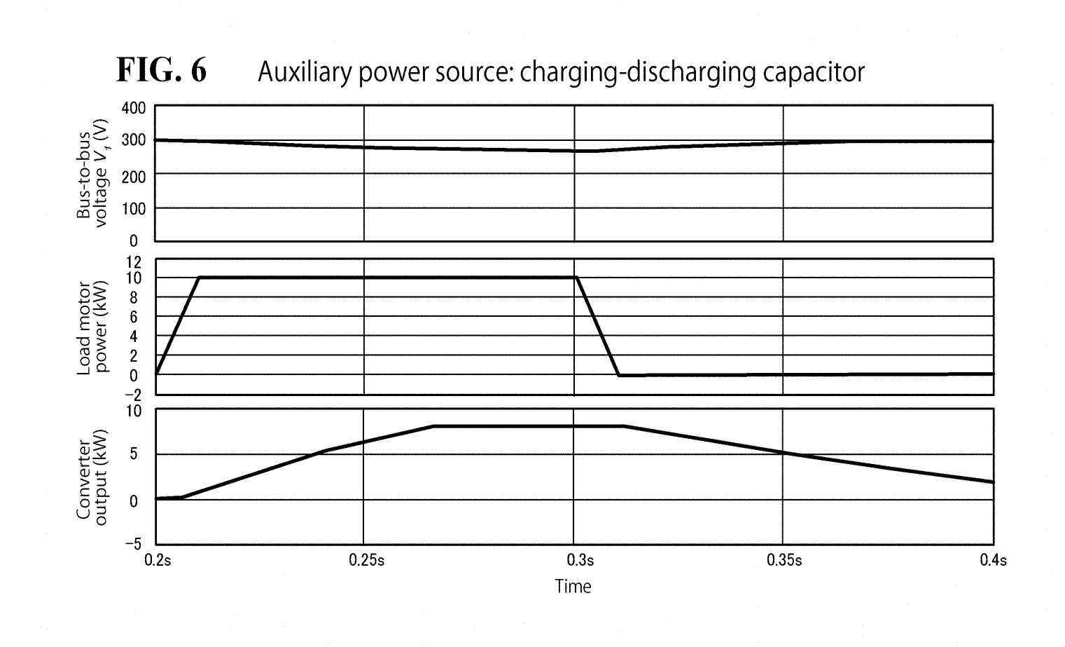

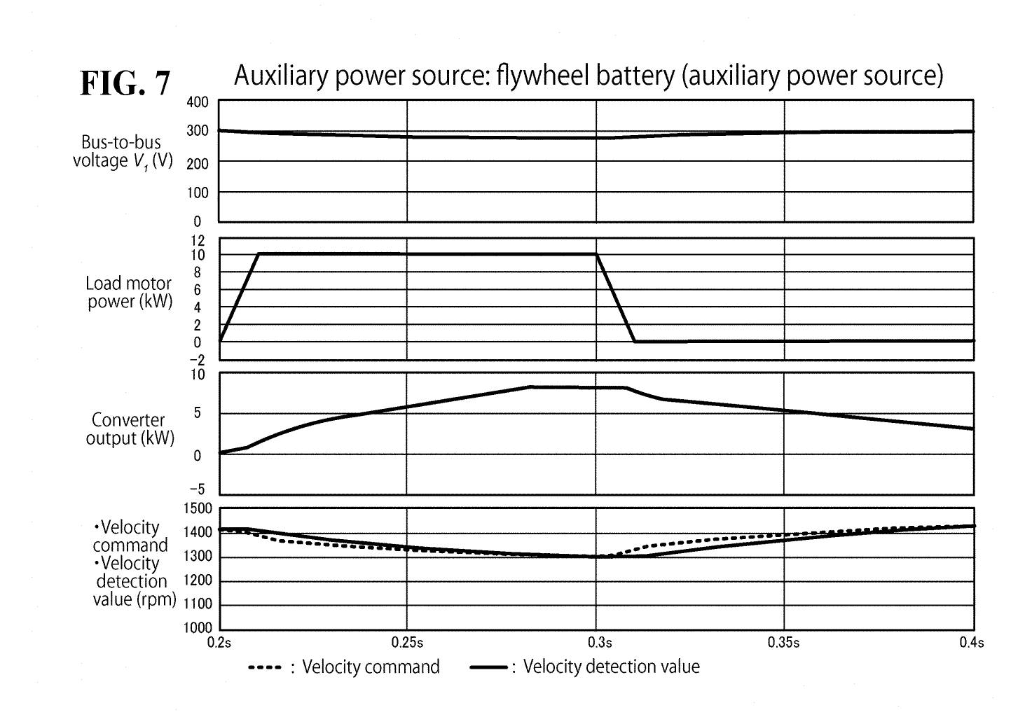

FIG. 5 shows time charts showing results of simulations performed in a comparative example (not illustrated) in which the main circuit includes no auxiliary power source. In the simulations, the load motor 3 was driven in a predetermined load pattern, and how the bus-to-bus voltage V₁, the load motor power, and the converter output changed over time was simulated. FIG. 6 shows time charts showing results of simulations performed in the comparative example illustrated in FIG. 3, in which the main circuit includes, as an auxiliary power source, the charging-discharging capacitor 41, which has a predetermined capacitance C. The simulations used the parameters used in FIG. 5. FIG. 7 shows time charts showing results of simulations performed in a configuration in which the main circuit includes, as an auxiliary power source, the auxiliary power source 8 according to this embodiment with a charging capacity identical to the capacitance C of the charging-discharging capacitor 41 illustrated in FIG. 6. In the simulations, how the velocity command ω (see the dotted line in the lowest chart of FIG. 7) and the velocity detection value ω_{FB} (see the solid line in the lowest chart of FIG. 7), in addition to the parameters illustrated in FIGS. 5 and 6, changed over time was simulated. For ease of illustration of the time charts, in the simulations, the load motor power is dropped to zero when the bus-to-bus voltage V₁ becomes 100 V or less (that is, no matter how high the load motor power becomes, the bus-to-bus voltage V₁ is kept around 100 V at the minimum).

In FIG. 5, where no auxiliary power source is provided, as the load motor power increases, the DC power on the DC bus line 13 falls short, resulting in a sharp decrease in the bus-to-bus voltage V₁. The sharp decrease in the bus-to-bus voltage V₁ causes a sharp increase in the converter output, adding more DC power. The additional DC power, however, is not enough to cover the deficiency in DC power on the bus-to-bus voltage V₁. The bus-to-bus voltage V₁, therefore, remains short, resulting in an abnormal operation state.

In FIG. 6, where the charging-discharging capacitor 41 is provided as an auxiliary power source, the bus-to-bus voltage V₁ decreases only gently when the load motor power increases, causing a large amount of the DC power on the DC bus line 13 to be consumed. Additionally, the range of variation of the bus-to-bus voltage V₁ is narrower. This is because even though the increase in the converter output is not enough to cover the deficiency in DC power, the deficiency is covered by DC power discharged from the charging-discharging capacitor 41 (this corresponds to power assistance). FIG. 6 also shows that after the load motor power has decreased, the bus-to-bus voltage V₁ gradually increases to its initial voltage. This is because the converter output decreases after the load motor power has decreased, and the amount of decrease in DC power caused by the load motor 3 accumulates in the charging-discharging capacitor 41 (this is equivalent to power peak shaving after power assistance).

In FIG. 7, where the auxiliary power source 8 according to this embodiment is provided, the range of variation over time of the bus-to-bus voltage V₁ is approximately as narrow as the case of the charging-discharging capacitor 41 illustrated in FIG. 6. This applies both in the case where the load motor power increases, causing a large amount of the DC power on the DC bus line 13 to be consumed and in the case where the load motor power decreases, stopping consumption of DC power. These findings lead to the assumption that the auxiliary power source 8 according to this embodiment is capable of performing charging and discharging operations through behaviors equivalent to behaviors of the charging-discharging capacitor 41 illustrated in FIG. 6.

It is noted that while there is a deficiency in the DC power on the DC bus line 13 due to an increase in the load motor power, the velocity detection value ω_{FB} of the power source motor 22 (see the solid line in the lowest chart of FIG. 7) shows a deceleration following the velocity command ω (see the dotted line in the lowest chart of FIG. 7) that is slightly lower than the velocity detection value ω_{FB}. This causes regeneration power to occur in the power source motor 22 due to slowing-down rotation of the flywheel 23 (rotational motion energy on the flywheel 23 is converted into electric energy), causing the auxiliary power source 8 to discharge DC power to the DC bus line 13. Thus, it can be seen that “power assistance control” is performed.

While there is an excessive amount of DC power on the DC bus line 13 due to a decrease in the load motor power, the velocity detection value ω_{FB} of the power source motor 22 (see the solid line in the drawing) shows an acceleration following the velocity command ω (see the dotted line in the lowest chart of FIG. 7) that is slightly higher than the velocity detection value ω_{FB}. This causes the power source motor 22 to consume DC power, accelerating the flywheel 23 (electric energy is converted into rotational motion energy on the flywheel 23) and causing the auxiliary power source 8 to be charged from the DC bus line 13. Thus, it can be seen that control equivalent to “power peak shaving control” is performed.

In the simulations, rotation velocity N₀ of the power source motor 22 is regarded as initial operation velocity of the power source motor 22. At the rotation velocity N₀, the power source motor 22 accumulates therein approximately half (Emax/2) the maximum amount of rotational motion energy, Emax, that the flywheel 23 is able to accommodate while the power source motor 22 is rotating at its maximum velocity, Nmax. In this case, the following balance equation of energy can be established:

$$\frac{1}{2} \times \frac{1}{2} {JN}_{max}^{2} = \frac{1}{2} {JN}_{0}^{2} \qquad ( 4 )$$

From this balance equation of energy, the initial operation velocity N₀ can be represented as follows:

$${N}_{0} = \frac{{N}_{max}}{\sqrt{2}} \qquad ( 5 )$$

Setting the initial operation velocity N₀ in this manner ensures that approximately equal allowance margins are provided in the charging capacity and the discharging capacity. This allows for a charging-discharging process performed in the order: power assistance→power peak shaving, as in the above simulations, and a charging-discharging process performed in the opposite order: power peak shaving→power assistance (not illustrated).

### Advantageous Effects of this Embodiment

As has been described hereinbefore, the motor controller 1 according to this embodiment includes the controller 24. The controller 24 controls the power source inverter 21, which performs supply and regeneration of power to and from the power source motor 22 relative to the DC power on the DC bus line 13, to cause the rotational angle velocity ω of the flywheel 23 to keep a positive correlation with the bus-to-bus voltage V₁ of the DC bus line 13. Performing this control of keeping a positive correlation eliminates the need for a complicated sequence of intentionally switching between the peak shaving control and the peak assistance control, enabling charging-discharging control of the auxiliary power source 8 to be performed with responsivity high enough to automatically accommodate to an increase or decrease in the bus-to-bus voltage V₁. This results in an improved auxiliary supply function of DC power implemented using a simplified control configuration.

Also in this embodiment, the controller 24 controls the power source inverter 21 to cause the rotational angle velocity ω of the flywheel 23 to keep a direct-proportional correlation with the bus-to-bus voltage V₁(ω=(C/J)^{1/2}·V₁) using the proportional coefficient ((C/J)^{1/2}). The proportional coefficient is represented by a square root of a ratio between a denominator represented by the inertia J (inertia moment) of the rotatable portion of the auxiliary power source 8 including the rotor of the power source motor 22 and the flywheel 23 (the rotatable portion also includes couplings and similar devices) and a numerator represented by the capacitance C of the charging-discharging capacitor 41 having accumulable energy equivalent to the inertia J. Although this control is simple, it ensures charging-discharging control as functional as when the single charging-discharging capacitor 41 (capacitor), which has approximately the same capacity as the auxiliary power source 8, is directly connected to the wirings of the DC bus line 13.

Also in this embodiment, the controller 24 calculates rotational angle velocity based on the bus-to-bus voltage V₁ detected from the DC bus line 13 and based on the proportional coefficient ((C/J)^{1/2}), and then inputs the rotational angle velocity into the power source inverter 21 as the velocity command ω. Then, the power source inverter 21 supplies power to the power source motor 22 to keep the velocity indicated by the input velocity command ω. This configuration ensures that the auxiliary power source 8 can be implemented as a flywheel battery with attention to details using a commonly available inverter (servo amplifier) for velocity control.

Also in this embodiment, the power source inverter 21 supplies power to the power source motor 22 to keep the rotational angle velocity indicated by the velocity command ω by feedback control using, as a feedback value, the rotational angle velocity (velocity detection value ω_{FB}) detected from at least one of the power source motor 22 and the flywheel 23. This configuration ensures charging-discharging control that is high in accuracy enough to deal with variations in the rotational angle velocity of the flywheel 23 in actual situations. It will be understood by those skilled in the art that when such high accuracy is not required of charging-discharging control with respect to the main circuit, feedforward control or other control (not illustrated) than feedback control may be employed.

### Modifications

Modifications of the above-described embodiment will be described below.

### Modification 1: Controller of Auxiliary Power Source Performs Velocity Sensor-less Control

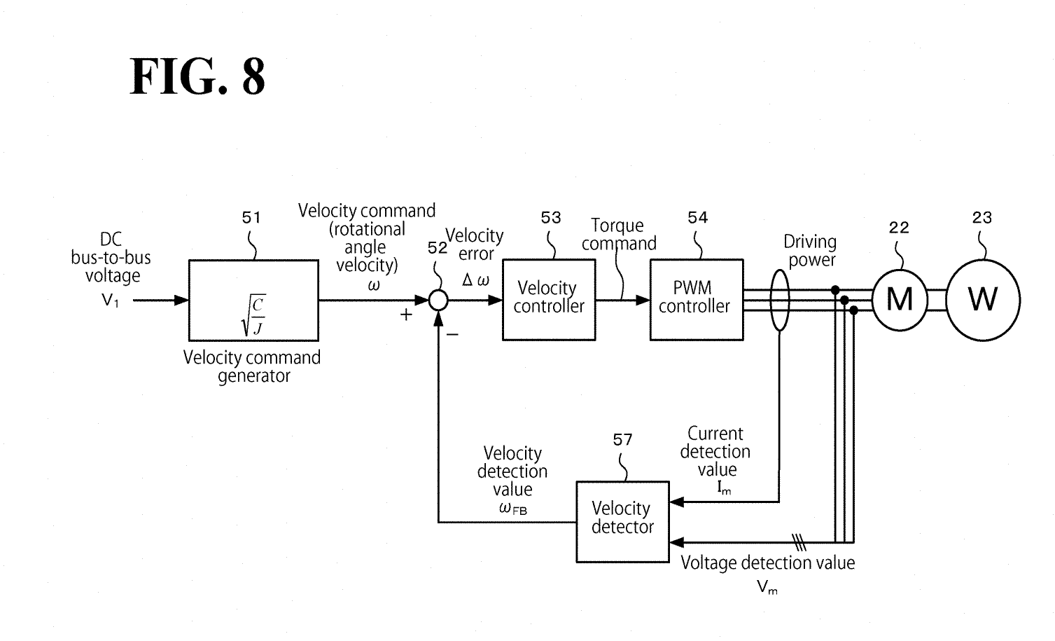

In the above-described embodiment, the power source motor 22 of the auxiliary power source 8 includes the position detector 56, such as an encoder. The position detector 56 detects the position detection value 9, and the velocity converter 55 of the controller 24 converts the detected position detection value θ into the velocity detection value ω_{FB} for use in speed feedback control. This configuration, however, is not intended in a limiting sense. A possible modification is illustrated in FIG. 8, which corresponds to FIG. 4. Referring to the feedback control blocks illustrated in FIG. 8, the current and voltage of the driving power supplied to the power source motor 22 are detected as current detection value Iₘ and voltage detection value Vₘ, respectively. Based on these detection values Iₘ and Vₘ, a velocity detector 57 calculates velocity detection value ω_{FB}, and this velocity detection value ω_{FB} is used for speed feedback control. This method of calculation performed by the velocity detector 57 may be a method used in known velocity sensor-less control, and will not be elaborated upon here. This configuration eliminates the need for the position detector 56, which can be expensive, resulting in a reduction in production cost of the system as a whole.

### Modification 2: Additional Notes

Another possible modification is that the power converter is implemented only by the converter 5 and the auxiliary power source 8 illustrated in FIG. 1. This configuration is suitable for, in particular, a power source used for stability purposes for electrical machines (such as a personal computer), other than the motor controller 1. Still another possible modification is that the auxiliary power source 8 alone constitutes an independent auxiliary power source. This configuration is suitable for, in particular, an application in which a typical DC power source connectable to a large number of electrical machines is connected to or disconnected from the DC bus line 13 as desired depending on the number of electrical machines connected.

As used herein, the terms “perpendicular”, “parallel”, and “plane” may not necessarily mean “perpendicular”, “parallel”, and “plane”, respectively, in a strict sense. Specifically, the terms “perpendicular”, “parallel”, and “plane” mean “approximately perpendicular”, “approximately parallel”, and “approximately plane”, respectively, with design-related and production-related tolerance and error taken into consideration.

Also, when the terms “identical”, “same”, “equivalent”, and “different” are used in the context of dimensions, magnitudes, sizes, or positions, these terms may not necessarily mean “identical”, “same”, “equivalent”, and “different”, respectively, in a strict sense. Specifically, the terms “identical”, “same”, “equivalent”, and “different” mean “approximately identical”, “approximately same”, “approximately equivalent”, and “approximately different”, respectively, with design-related and production-related tolerance and error taken into consideration.

Otherwise, the embodiments and modifications may be combined in any manner deemed suitable.

Obviously, numerous modifications and variations of the present disclosure are possible in light of the above teachings. It is therefore to be understood that within the scope of the appended claims, the present disclosure may be practiced otherwise than as specifically described herein.

What is claimed is:

1. A motor controller, comprising:
an AC-to-DC converter configured to convert AC power from an AC power source into DC power and configured to supply the DC power to a DC bus line;
an auxiliary power source configured to charge the DC bus line with the DC power and to discharge the DC power from the DC bus line; and
a first inverter configured to control power supply to a motor using the DC power from the DC bus line,
wherein the auxiliary power source includes a rotating electrical machine, a flywheel connected to the rotating electrical machine, a second inverter configured to supply power to the rotating electrical machine using the DC power on the DC bus line and configured to regenerate the power from the rotating electrical machine into the DC power on the DC bus line, and control circuitry configured to control the second inverter to cause a rotational angle velocity of the flywheel to keep a positive correlation with a bus-to-bus voltage of the DC bus line.

2. The motor controller according to claim 1, wherein the control circuitry is configured to control the second inverter to cause the rotational angle velocity to keep a direct-proportional correlation with the bus-to-bus voltage using a proportional coefficient represented by a square root of a ratio between a denominator represented by an inertia of a rotatable portion of the auxiliary power source comprising a rotor of the rotating electrical machine and the flywheel and a numerator represented by a capacitance of a capacitor having accumulable energy equivalent to the inertia.

3. The motor controller according to claim 2, wherein the control circuitry is configured to calculate a rotational angle velocity based on the proportional coefficient and based on the bus-to-bus voltage detected from the DC bus line, and configured to input the rotational angle velocity into the second inverter as a velocity command, and the second inverter is configured to supply the power to the rotating electrical machine to keep a velocity indicated by the velocity command.

4. The motor controller according to claim 3, wherein the second inverter is configured to supply the power to the rotating electrical machine to keep the velocity indicated by the velocity command by feedback control using, as a feedback value, the rotational angle velocity detected from at least one of the rotating electrical machine and the flywheel.

5. A power converter, comprising:
an AC-to-DC converter configured to convert AC power from an AC power source into DC power and configured to supply the DC power to a DC bus line; and
an auxiliary power source configured to charge the DC bus line with the DC power and to discharge the DC power from the DC bus line,
wherein the auxiliary power source includes a rotating electrical machine, a flywheel connected to the rotating electrical machine, a second inverter configured to supply power to the rotating electrical machine using the DC power on the DC bus line and configured to regenerate the power from the rotating electrical machine into the DC power on the DC bus line, and control circuitry configured to control the second inverter to cause a rotational angle velocity of the flywheel to keep a positive correlation with a bus-to-bus voltage of the DC bus line.

6. An auxiliary power source for charging a DC bus line with DC power and discharging the DC power from the DC bus line, comprising:
a rotating electrical machine;
a flywheel connected to the rotating electrical machine;
an inverter configured to supply power to the rotating electrical machine using the DC power on the DC bus line and configured to regenerate the power from the rotating electrical machine into the DC power on the DC bus line; and
control circuitry configured to control the inverter to cause a rotational angle velocity of the flywheel to keep a positive correlation with a bus-to-bus voltage of the DC bus line.

7. A method for controlling an auxiliary power source, comprising:
controlling an inverter of the auxiliary power source to cause a rotational angle velocity of a flywheel of the auxiliary power source to keep a positive correlation with a bus-to-bus voltage of a DC bus line,
wherein the auxiliary power source includes a rotating electrical machine, the flywheel connected to the rotating electrical machine, and the inverter configured to supply power to the rotating electrical machine using DC power on the DC bus line and configured to regenerate the power from the rotating electrical machine into the DC power on the DC bus line.

8. The power converter according to claim 5, wherein the control circuitry is configured to control the second inverter to cause the rotational angle velocity to keep a direct-proportional correlation with the bus-to-bus voltage using a proportional coefficient represented by a square root of a ratio between a denominator represented by an inertia of a rotatable portion of the auxiliary power source comprising a rotor of the rotating electrical machine and the flywheel and a numerator represented by a capacitance of a capacitor having accumulable energy equivalent to the inertia.

9. The power converter according to claim 8, wherein the control circuitry is configured to calculate a rotational angle velocity based on the proportional coefficient and based on the bus-to-bus voltage detected from the DC bus line, and configured to input the rotational angle velocity into the second inverter as a velocity command, and the second inverter is configured to supply the power to the rotating electrical machine to keep a velocity indicated by the velocity command.

10. The power converter according to claim 9, wherein the second inverter is configured to supply the power to the rotating electrical machine to keep the velocity indicated by the velocity command by feedback control using, as a feedback value, the rotational angle velocity detected from at least one of the rotating electrical machine and the flywheel.

11. The auxiliary power source according to claim 6, wherein the control circuitry is configured to control the inverter to cause the rotational angle velocity to keep a direct-proportional correlation with the bus-to-bus voltage using a proportional coefficient represented by a square root of a ratio between a denominator represented by an inertia of a rotatable portion of the auxiliary power source comprising a rotor of the rotating electrical machine and the flywheel and a numerator represented by a capacitance of a capacitor having accumulable energy equivalent to the inertia.

12. The auxiliary power source according to claim 11, wherein the control circuitry is configured to calculate a rotational angle velocity based on the proportional coefficient and based on the bus-to-bus voltage detected from the DC bus line, and configured to input the rotational angle velocity into the inverter as a velocity command, and the inverter is configured to supply the power to the rotating electrical machine to keep a velocity indicated by the velocity command.

13. The auxiliary power source according to claim 12, wherein the inverter is configured to supply the power to the rotating electrical machine to keep the velocity indicated by the velocity command by feedback control using, as a feedback value, the rotational angle velocity detected from at least one of the rotating electrical machine and the flywheel.

14. The method to claim 7, further comprising:
controlling the inverter to cause the rotational angle velocity to keep a direct-proportional correlation with the bus-to-bus voltage using a proportional coefficient represented by a square root of a ratio between a denominator represented by an inertia of a rotatable portion of the auxiliary power source comprising a rotor of the rotating electrical machine and the flywheel and a numerator represented by a capacitance of a capacitor having accumulable energy equivalent to the inertia.

15. The method according to claim 14, further comprising:
calculating a rotational angle velocity based on the proportional coefficient and based on the bus-to-bus voltage detected from the DC bus line;
inputting the rotational angle velocity into the inverter as a velocity command; and
supplying, by the inverter, the power to the rotating electrical machine to keep a velocity indicated by the velocity command.

16. The method according to claim 15, further comprising:
supplying, by the inverter, the power to the rotating electrical machine to keep the velocity indicated by the velocity command by feedback control using, as a feedback value, the rotational angle velocity detected from at least one of the rotating electrical machine and the flywheel.

17. The motor controller according to claim 1, wherein the control circuitry is configured to calculate a rotational angle velocity based on a proportional coefficient and based on the bus-to-bus voltage detected from the DC bus line, and configured to input the rotational angle velocity into the second inverter as a velocity command, and the second inverter is configured to supply the power to the rotating electrical machine to keep a velocity indicated by the input velocity command.

18. The motor controller according to claim 1, wherein the second inverter is configured to supply the power to the rotating electrical machine to keep the velocity indicated by an input velocity command by feedback control using, as a feedback value, the rotational angle velocity detected from at least one of the rotating electrical machine and the flywheel.
